(19) United States
(12) Patent Application Publication
(10) Pub. No.: US 2025/0181925 A1
(43) Pub. Date: Jun. 5, 2025

(54) Attribute Prediction and Recommendation

(71) Applicant: The Ageing Equation Pty Ltd, Algester (AU)

(72) Inventor: Safdar Ali, Algester (AU)

(73) Assignee: The Ageing Equation Pty Ltd, Algester (AU)

(21) Appl. No.: 18/961,397

(22) Filed: Nov. 26, 2024

(30) Foreign Application Priority Data
Dec. 1, 2023 (AU) 2023903889

(51) Int. Cl. G06N 3/09; G06N 3/042

(52) U.S. Cl. CPC G06N 3/09; G06N 3/042

(57) ABSTRACT

A computer-implemented method comprising: accessing data related to at least one attribute of at least one item over time; pre-processing the data by encoding the data to provide labelled data; obtaining a set of attribute predictions by applying the labelled data to a combination prediction model, wherein the combination prediction model comprises two or more supervised learning workflows; and determining and displaying a recommended subset of attribute predictions in response to a user selection, wherein the two or more supervised learning workflows comprise: an integrated neural network, and a random forest model.

### CROSS-REFERENCE TO RELATED APPLICATIONS

The present application claims priority from Australian Provisional Patent Application No 2023903889 filed on 1 Dec. 2023, the contents of which are incorporated herein by reference.

### TECHNICAL FIELD

The present disclosure broadly relates to prediction methods and systems and, more particularly, to a system for, and a method of, predicting and recommending user-selectable attributes.

### BACKGROUND

Existing tools to support determining attributes of complex dynamic systems lack sophistication and do not always provide accurate or useful results for users wanting to select features or attributes within such systems. Moreover, it has been observed that not all existing machine learning models or algorithms offer equal precision for both numeric and classification based prediction problems.

One example is the prediction of pricing which relies on several factors, many of which vary over time in manners that are not easily predictable. Property prices and accommodation prices are such examples.

Referring to accommodation prices, for example, aged care providers generally determine accommodation prices for their facility rooms based on observations and professional judgement. However, determining and setting room prices for residential aged care facilities is often not been based on evidence, resulting in overpricing or under-pricing. Currently no tools exist that can provide a useful or accurate pricing mechanism due to the complexity of the problem.

There are many examples of complex problems across various domains that require sophisticated artificial intelligence (AI) based solutions due to the intricate interplay of influencing factors. In healthcare, for example, predicting costs involves analysing patient demographics, medical histories, insurance coverage, treatment types, regional healthcare pricing, and other variables, making it essential for predictive models to account for these interdependencies to reduce financial risks for providers and patients. Similarly, supply chain optimisation presents challenges such as raw material availability, production schedules, transportation costs, demand forecasting, geopolitical factors, and environmental conditions. AI systems capable of dynamic pricing and real-time inventory management can improve efficiency and reduce waste in this context.

However, AI systems provide “black box” type solutions where some models, particularly deep learning algorithms, operate in highly complex ways that are not inherently interpretable. Mitigating this issue to enhance the transparency and interpretability of AI systems is not straightforward, especially if the accuracy of deep learning algorithms is still required.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Automating complex predictions and improving the accuracy and suitability of data is desirable for many applications. Supervised learning artificial intelligence can be used, but the inventor has found that this only works if applied in an appropriate way, and as a result has invented a novel prediction tool for such complex predictions. Specifically, the novel methods described herein are able to provide the flexibility and accuracy of deep learning, however with the added benefit of allowing visibility regarding the impact of various factors. In other words, the process does not resemble a “black box”, but instead allows a user to understand how contributing factors impact the calculated results. This ensures that results are both actionable and understandable

Because of the complexity of the types of problems considered herein, correctly identifying the contributing factors is challenging. The methods described herein achieve this by a combination method whereby the relevant variables are trained with neural networks. Significantly, the output layer of the neural network is then further trained on random forest to improve the usefulness of the results because the random forest step allows visibility regarding the impact of the respective variables.

In one aspect there is provided a computer-implemented method comprising: accessing data related to at least one attribute of at least one item over time; pre-processing the data by encoding the data to provide labelled data; obtaining a set of attribute predictions by applying the labelled data to a combination prediction model, wherein the combination prediction model comprises two or more supervised learning workflows; and determining and displaying a recommended subset of attribute predictions in response to a user selection, wherein the two or more supervised learning workflows comprise: an integrated neural network, and a random forest model.

The integrated neural network may be followed by the random forest model, and the random forest model may replace a last layer, being an output layer, in the neural network.

The combination prediction model may have a depth between 15 and 40 layers, and the random forest model may have between 500 and 2,000 trees.

The random forest may have a leaf size of 5, and a mean tree depth of 18.

The two or more supervised learning workflows may comprise one or more of: a linear regression, simple regression, multiple regression, ensemble learning, a Support Vector Machine (SVM), K-Nearest Neighbours (KNN), a gradient boosting algorithm, and a logistic regression model.

The combination prediction model may be formed using joint, simultaneous training of the integrated neural network and the random forest model.

The combination prediction model may be trained by executing the integrated neural network and the random forest model in combination to classify training data.

Pre-processing the data may comprise processing different data variables separately; and joining the different data variables to form one data input comprising data variables from two or more feature categories. The one data input may comprise a numerical data variable and a categorical data variable.

Pre-processing the data may comprise converting all data to a numerical form usable by the integrated neural network.

The integrated neural network may comprise: a body layer with about 32 dense layers; and an output layer with about 8 dense layers, wherein “dense layers” are layers that apply weights to substantially all nodes from a previous layer.

The integrated neural network may comprise: an activation function; and an optimisation algorithm.

Throughout this specification the word “comprise” or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1 is a block diagram of a network system suitable for implementing embodiments of the methods described herein.

FIG. 2 is a block diagram of a computer system suitable for implementing one or more components in FIG. 1.

FIG. 3 is a block diagram of the structure of an embodiment of a combination neural network with random forest.

FIG. 4 is a schematic representation of the model training process.

FIG. 5A illustrates a first loss function comparison.

FIG. 5B illustrates a second loss function comparison.

FIG. 6 is a flow diagram of a method of predicting and recommending attributes.

### DETAILED DESCRIPTION

Existing analysis tools that are able to be used, for example, for valuation and price prediction, lack sophistication and do not always provide accurate or useful results. To enhance interpretability, hybrid approaches that combine human expertise with AI can be used. For example, AI systems can provide predictions along with explanations that are then validated or adjusted by human experts, ensuring accountability and reducing reliance on “black box” outputs. For real-world applications requiring high-stakes decisions, such as in healthcare or finance, transparent model validation processes can ensure that stakeholders understand the reliability and limitations of the AI system. Techniques like counterfactual analysis, fairness testing, and robustness checks can make models more transparent and trustworthy.

However, these methods are not automated and require human input and analysis.

Some prior art systems implement explainable AI (XAI) techniques. These methods aim to provide insights into how an AI model arrives at its predictions. For instance, feature importance rankings can show which inputs were most influential in generating an outcome. Tools like SHAP (Shapley Additive Explanations) and LIME (Local Interpretable Model-agnostic Explanations) offer frameworks to analyse the contributions of individual features for specific predictions, regardless of the model's underlying complexity.

However, these techniques suffer from both scalability and complexity issues. For example, SHAP has a high computational cost, considering all possible combinations of input features. LIME on the other hand suffers from approximation errors and model instability, so that the output is inconsistent and can be unreliable.

Described herein are analysis and prediction methods based on artificial intelligence, that use a unique hybrid model of neural networks and decision trees. These methods are useful for several applications. For example, in urban real estate development, the methods described herein are able to take into consideration market trends, zoning laws, demographic shifts, infrastructure developments, and economic projections in order to assess location viability and forecast returns on investment. In addition, it is also possible to determine which of these factors impact the outcome and in what way.

As an example, aged care providers often do not undertake detailed market and competitor research to determine room accommodation costs. Without gaining key market insights such as the occupancy levels of aged care facilities in the local area, one cannot be certain that the adopted approach is effective or not. Providers also do not take other factors into consideration such as facility stock condition and building structure. Some aged care providers engage consultancy services to undertake their price review analysis. These consultants normally undertake a simple linear regression analysis (by sampling the local aged care facilities) between two variables to determine the potential accommodation price for their clients. Though undertaking a linear regression would produce insights which are more informative than just a wild guess, it lacks the impact of, and relationships between, all the relevant variables, thus likely to lead to biased and/or inaccurate results.

### System Overview

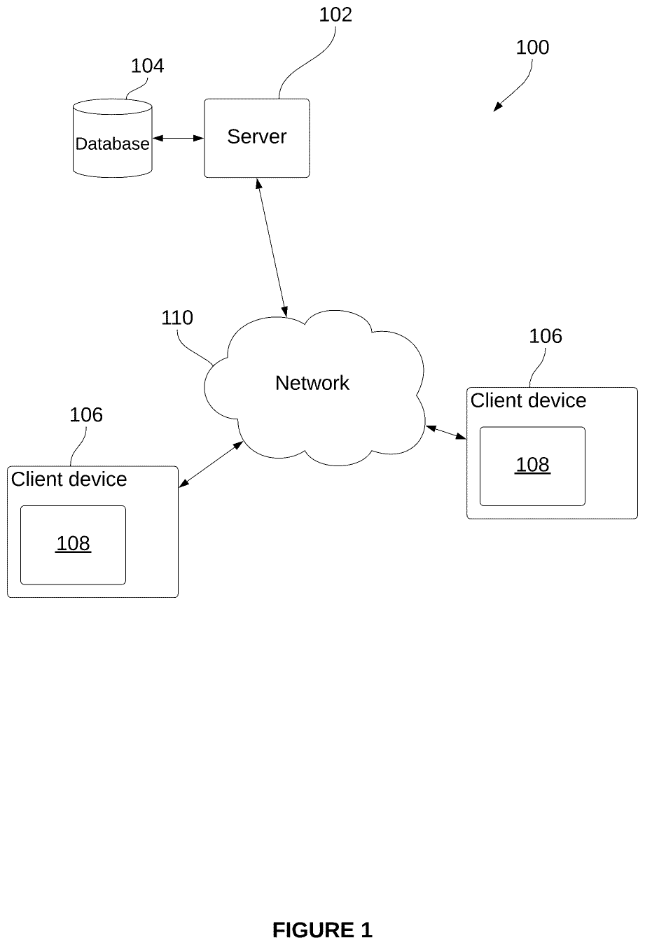

FIG. 1 of the drawings shows a networked system 100 suitable for implementing embodiments of the methods described herein. The system 100 includes a server 102 with a database 104, and at least one client device 106 with a client program 108. The client device 106 is in communication with the server 102 via a network 110, for example the Internet.

In some embodiments, the client program 108 may be available in more than one form or embodiment, for example with features depending on the user requirements, subscription features, location, etc. The client program may have a user interface adapted for sellers or providers, as well as a user interface for buyers or users, etc.

The server 102 may include a communications server and an application server. The communication server may include one or more of a web server providing a web interface, an API server providing a program interface, a messaging server providing a messaging interface, or the like.

The database 104 may include one or more of, for example, a subscriber database, a property database, a feature database, or the like.

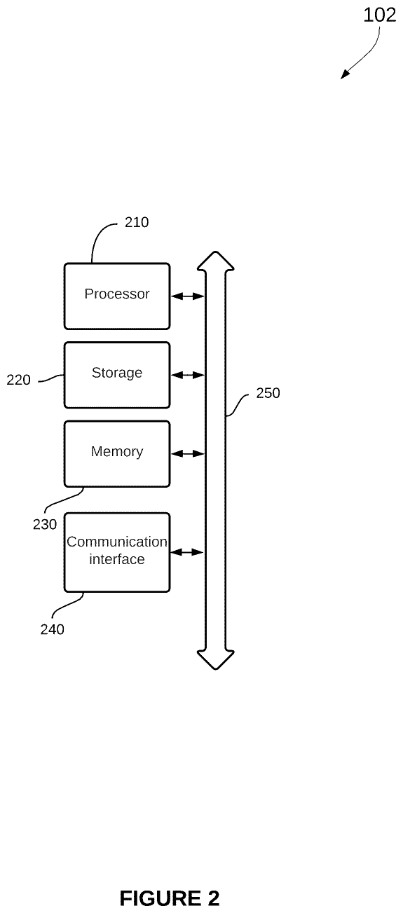

Referring to FIG. 2 of the drawings, computing devices that form part of the system, such as the server 102, may comprise one or more devices such as a desktop computer with a suitable operating system. The server 102 includes a processor 210, storage 220, memory 230, and a communication interface 240 for communicating with external entities. The various components of the server 102 are interconnected via a bus 250.

The client program 108, for example in the form of a web or mobile application (or “app”) supports the display of information to the user on a user interface (for example a display screen) of the client device 106.

The user interface may be provided to include, for example, a map style application using, e.g., the ArcGIS platform. The predicted attributes (e.g., room prices, weather prediction, competitor activity, etc.) may be geo-coded on the ArcGIS platform. The interactive mapping app may provide information on existing service offerings, demographic characteristics, supply-demand projections, or the like. The user interface may also take a form of Power BI style dashboards where information is presented in charts and graphs.

### Prediction Model

The methods described herein combine two or more supervised learning workflows, for example combining neural networks and random forest (a machine learning algorithm that combines the output of multiple decision trees to reach a single result).

Neural networks may be used for identifying patterns and features. However, neural networks, particularly deep ones, can make it challenging to understand how they arrive at a particular prediction. The combination approach described herein is advantageous because using a decision tree or random forest complements the neural network when interpretability is useful.

The novel combination model provides insights into feature importance and decision-making, which would be challenging with a complex neural network architecture. Models like decision trees or logistic regression can be more interpretable than complex neural networks. Combining them allows the methods described herein to maintain interpretability while benefiting from the expressive power of neural networks.

Other benefits provided by the combination approach include, for example, enhancing robustness and generalisation (making the model perform well on diverse datasets), better performance on minority classes if a dataset includes imbalances, and combining models with complementary strengths resulting in a more robust and accurate model. In addition, transfer learning and pre-training on large datasets can be beneficial if the labelled data for the target task is limited.

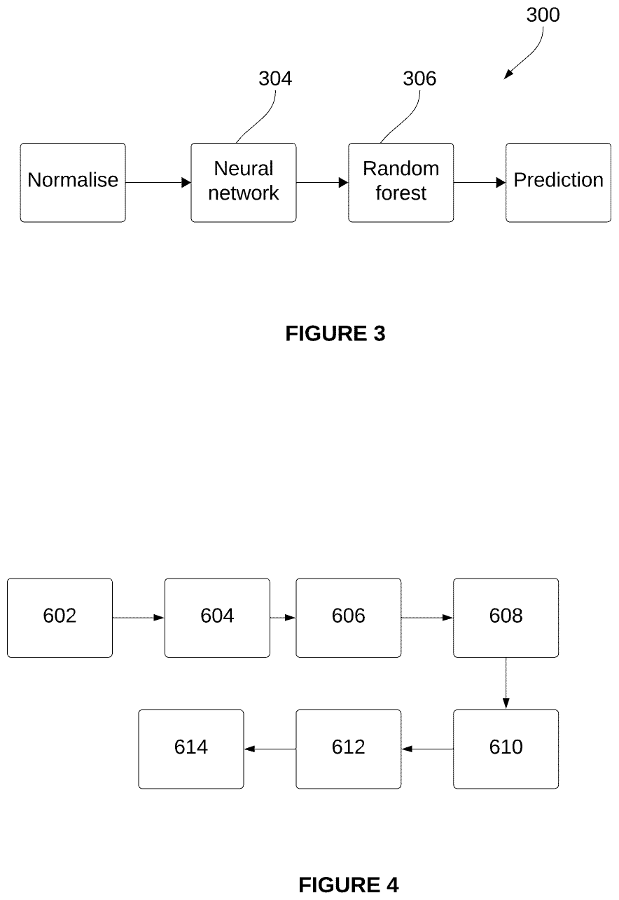

Typically, when only using a neural network to predict a numeric value (i.e., a regression related task), the input data would be normalised and provided to the neural network which would then output a predicted value. However, in the combination model the last layer or output layer of the neural network becomes the input of the random forest model. The structure of an embodiment of a model 300 comprising a combination neural network 304 with random forest 306 is shown in FIG. 3.

To avoid overfitting yet still have an effective model, the inventor has found that the selection of the number of dense layers for the neural network and the number of trees at the random forest level impacts the results obtained.

While keeping the main model structure the same, combinations of neural networks and the number of trees may vary to achieve the optimal results with a reduced risk of overfitting for different prediction problems. For example, to predict the optimal prediction prices for residential aged care accommodation prices, the intermediate layer (or hidden layer) may consist of 128 nodes and the last or output layer may consist of 64 nodes. In some embodiments, the neural network is trained at 2000 epochs, and for the next training step, for the random forest based model, 3000 trees produce the optimal results.

For the disaster prediction test, the hidden layer may consist of 512 nodes and the last layer may consist of 128 nodes trained at 500 epochs. The Decision Forest model may consist of 500 trees. For classification prediction problems including binary classification problem (example—credit default rates), the hidden and output layers may be made up of 256 nodes and 128 nodes respectively. The model may be trained with 2000 epochs with selection of 3000 trees for the Decision Forest training step.

Alternative embodiments may include other model combinations. For example, linear regression between two variables such as room size to predict room price, or using a neural network and random forest individually to predict room prices. In other embodiments simple multiple regression can also be an alternative which would involve the prediction of room price by using multiple variables which may have a linear relationship with room price.

In alternative embodiments, neural networks may be combined with ensemble methods, such as bagging or boosting. Ensemble learning involves training multiple models and combining their predictions. This can improve generalisation and reduce overfitting.

In some embodiments, the neural networks may be trained using engineered features extracted from the data before being fed into the network. This is relevant when domain knowledge can be used to create informative features that help the neural network better capture the underlying patterns in the data.

In alternative embodiments, Support Vector Machines (SVMs) may be used in conjunction with neural networks for classification tasks. SVMs are effective to incorporate binary classification, and combining them with neural networks might enhance the model's ability to discriminate between classes.

In some embodiments, K-Nearest Neighbours (KNN) may be used alongside neural networks for tasks such as imputation of missing values or generating synthetic samples to balance class distributions in the dataset.

In some embodiments, logistic regression models can be used in conjunction with neural networks, for example in binary classification tasks. Logistic regression is computationally less intensive and can provide a baseline for performance comparison.

In some embodiments, gradient boosting algorithms, like Gradient Boosted Trees or XGBoost or LightGBM, may be combined with neural networks to improve predictive performance and handle different types of data.

A gradient boosting algorithm performs differently to random forest. Gradient boosting models create multiple trees over several iterations. Each tree learns and corrects the errors of the previous tree. The gradient boosting method tends to be less interpretable than random forest but may provide more accurate results for large and complex datasets. However, gradient boosting algorithms are generally more training expensive and have a lower training rate.

Table 1 compares the performance of a neural network plus random forest method and a neural network plus gradient boosting method. The sample dataset contained over 300,000 data entries of bank customers to predict the likelihood of credit defaults of customers based on several variables. In terms of accuracy, there may not appear to be a great difference between the two models, however, for this example the lower log loss suggests that the neural network plus gradient boosting is a superior model.

TABLE 1
A Comparison Of Neural Network Plus Random Forest Model With Neural

| Model | NN + RF + hypertunning | NN + GB + hypertunning |
|---|---|---|
| Structure | Neural network model | Neural network model |
| | y = | [symbol] _keras.layers.Concatenate( )(nn_processed_inputs) |
| | tf_keras.layers.Concatenate( )(nn_{—} | [symbol] _keras.layers.Dense(256, activation=tf.nn.relu6)(y) |
| | processed_inputs) | last_layer = tf_keras.layers.Dense(128, |
| | [symbol] y = tf_keras.layers.Dense(256, | activation=tf.nn.relu, name=“last”)(y) |
| | activation=tf.nn.relu6)(y) | Gradient boosted trees |
| | [symbol] _layer = tf_keras.layers.Dense(128, | [symbol] er = tfdf.tuner.RandomSearch(num_trials=600) |
| | activation=tf.nn.relu, | tfdf.keras.GradientBoostedTreesModel(preproces |
| | name=“last”)(y) | sing=nn_without_head, tuner=tuner, |
| | Random forestmodel | task=tfdf.keras.Task.CLASSIFICATION, |
| | [symbol] ras.RandomForestModel(preproces | hyperparameter_template=“benchmark_rank1@v |
| | sing=nn_without_head, num_trees | 1”) |
| | = 300, | |
| | task=tfdf.keras.Task.CLASSIFICAT | |
| | ION, | |
| | hyperparameter_template=“bench | |
| | mark_rank1”) | |
| Log loss | 0.54 | 0.43 |
| Accuracy | 0.82 | 0.82 |

[symbol]

indicates data missing or illegible when filed

### Network Plus Gradient Boosting Model

The models used may be combined in a number of ways.

In one embodiment ensemble methods may be used by training multiple models and combining their predictions. This can be done by training different neural network architectures independently and aggregating their outputs or by combining the neural network predictions with those of other models, such as decision trees, support vector machines, or simpler models. The ensemble method used may include bagging and/or boosting.

Gradient boosting models create multiple trees over several iterations. Each tree learns and corrects the errors of the previous tree. Although gradient boosting methods can be less interpretable than random forest methods, embodiments using gradient boosting may provide more accurate results, particularly for large and complex datasets. However, because gradient boosting algorithms are generally more expensive and have a lower training rate, for some applications the embodiments that use random forest may be preferred. The number of tuner trials impacts the performance. For a gradient boosted tuner, 50-600 trials offer good results for some types of datasets as described herein.

In other embodiments, stacking, or meta-ensemble, may be used. This involves training multiple models, including a neural network, and then training a meta-model to make predictions based on the outputs of the initial models. The meta-model learns to combine the predictions of the base models. Neural networks can be one of the base models in this setup.

In other embodiments, a cascade model may be used. In this implementation, the output of one model becomes the input for another. For example, if a neural network is used for an initial prediction, then the output of this prediction becomes part of the input for another model. This cascade may continue through models until the final prediction is made.

In some embodiments, feature engineering and/or pre-processing may be used. Complementary processes, such as a dimensionality reduction technique or a feature engineering method, may be applied before feeding the data into the neural network. For example, principal component analysis (PCA) may be used to reduce the dimensionality of the input data before passing it to a neural network.

Some embodiments allow for the joint training of multiple models. For example, in multi-task learning, a neural network is trained on multiple related tasks simultaneously, sharing information across tasks to improve overall performance.

Training the prediction model may be understood with reference to FIG. 4 of the drawings. The method 600 of training the prediction model starts with preparing the training data by loading or receiving the data at 602, cleaning or pre-processing the data at 604, inputting the data at 606, and data conversion and normalisation at 608. The neural network at 610 and the random forest regression at 612 are executed in combination to classify the training data. At this point the model is ready for evaluation and to be used for prediction at 614.

### Training Data

The model is trained on multiple factors that can impact the predicted parameter(s), for example property price, where the factors may include one or more of stock condition, building structure, room type, room size per resident (e.g., in case of single ensuites, the residents receive the entire size, and for shared rooms the room size may be divided by maximum occupancy), median house price of the area that the facility is located in, the ‘Index of Relative Socio-Economic Decile’ ranking of the SA2 within Australia (the ranking of the SA2 was taken into account), and income levels for the target market (e.g., people over the age of 70 as a percentage of the SA2 where the facility is located).

For the exemplary embodiment of aged care residence pricing, prediction methods described herein can be used to show which of the data inputs used have what kind of impact on the room price. For example, because government funding is attached to each bed, it is important to maintain the occupancy levels in aged care. A vacant bed is going to cost the provider more than an increase in pricing for the occupied beds. Therefore the real occupancy ratios used for residential aged care is significant to achieve the optimal price. Accordingly, based on the relevant data, the methods described herein will not always suggest a price increase to providers; in many cases the model will suggest price reduction because the model is able to detect if the area has lower occupancy levels so that an increase in prices may lead to vacant beds.

### Data Pre-Processing

Data cleaning and integration is conducted. Different data variables are processed separately as separate inputs. For example, the data type for the model may be defined to process the information further as indicated in Appendix A. Then, after further processing, the different inputs may be joined to form one input by using a concatenate function (available from, e.g., a Numpy or TensorFlow library). The concatenate function can be used to integrate or join different sets of features or data sources before feeding them into the model. For example, with both numerical features and categorical features stored in separate arrays or data frames, these may be concatenated along an appropriate axis to create a unified input for the model. This integration step ensures that all relevant information is considered during training and/or prediction.

In the methods described herein, the training data undergoes pre-processing. For example, after loading the data in a python programming environment, the data may be cleaned with removal of null values and by allocating the appropriate data format for different variables.

After data cleaning, the data is split between training and testing subsets. 30% of the entire data (as test data) is separated from the entire dataset for validation and model evaluation purposes.

To conduct neural network training, the data is converted to a numeric form. As the data inputs include variables that are categorical, they have to be encoded before the neural network step. Neural networks do not typically work with categorical variables; even if all the data inputs are numeric, they cannot be processed by neural networks. They need to be converted to NumPy arrays or tensors before conducting neural network training.

The categorical variables are converted to numeric form using, for example, a one-hot-encoding method (one-hot encoding is a form of dictionary that allocates a label to each category). This may be achieved using, for example, a CategoryEncoding function. In other embodiments, for example when dealing with high-cardinality categorical features, embeddings can be learned during the training of a neural network and capture relationships between different categories.

In some embodiments, a further step of converting the data inputs into a NumPy array or tensors is included so that the neural networks can process the data.

In some embodiments each data variable in the training dataset may also be normalised. This step will shift and scale inputs into a distribution centred around 0 with standard deviation 1. This is done by precomputing the mean and variance of the data and calling a “(input−mean)/sqrt (var)” function at runtime. The main reason to normalise data is to make queries simpler and eliminate redundant information. This step scales the features to a common range and enables the model to learn better with faster convergence.

Each variable (which is a separate input), is then combined to form one input.

In the accommodation example, the dependent variable may be ‘room price’, which is accordingly removed from both subsets as a label. The training data (70% of the original dataset) is then ready for training.

### Model Training

Neural network and random forest models are trained together as the random forest layer replaces the neural network output layer, using the information from the previous layer to compile the random forest model to make predictions.

The data is trained using a neural network, for example using Tensorflow neural network workflows. Each feature in the model is added as an input with its original data format such as string, float, etc.

In some embodiments, different models may be run to find the most suitable model. In some embodiments, spatial factors may be incorporated, such as distance to water bodies, points of interest, transport points, or the like. A supervised learning method (e.g., Forest based regression and classification) may then be used to train the model, while Geodatabase files may be used to incorporate the spatial variables.

The neural network model is defined, and the number of layers are allocated. Increasing the number of layers in the model (referred to as its depth) increases the capacity of the model and training deep models, e.g. those with many hidden layers, can be computationally more efficient than training a single layer network with a vast number of nodes. However, overfitting occurs when the number of hidden layers becomes very large compared to the complexity of the problem; a consequence of overfitting is that the neural network has limited ability to adapt to changing or diverse environments and scenarios.

The inventor has found that for the scale of this type of problem, a model having one body layer with 32 ‘dense’ layers is suitable (a dense layer applies weights to all nodes from the previous layer). The output of this embodiment of the model has 8 dense layers.

The neural network includes both an activation function and an optimisation algorithm. These are distinct processes, but do work together in the training process.

The activation function is a mathematical operation applied to each node (neuron) in a neural network, typically at every layer except the input layer. It introduces non-linearity to the network, enabling it to learn complex relationships in the data. While the activation function and optimisation algorithm are separate components, they work together in the training process. The activation function affects the non-linearity and expressiveness of the neural network, influencing its ability to capture complex patterns in the data. The optimisation algorithm guides how the network's weights are adjusted to minimise the loss function during training.

In some embodiments, an optimisation algorithm may also be implemented, such as a stochastic gradient descent (SGD) algorithm adapted to update the weights of the neural network during training. For example, the neural network may be compiled with the Adaptive Moment Estimation (‘Adam’) optimiser with a loss function mean squared error (MSE). In an exemplary embodiment, the model is fit for training a dataset with 200 epochs, for which the model provides about 3872 total parameters.

The optimisation algorithm is responsible for adjusting the weights of the neural network during the training phase to minimise the difference between the predicted outputs and the actual targets. The optimisation algorithm defines how the network learns from the training data and updates its weights.

In other embodiments the optimisation algorithm may include a Root Mean Square Propagation (RMSprop) or Adaptive Gradient Algorithm (Adagrad).

Input data encoding and normalisation are used for dense layers. For example, categorical features are converted to numeric features by using a method like one-hot-encoding. After processing each data input, the data inputs are joined to process as a dense layer:

The output of the neural network model is provided to the next stage which includes a classifier, for example a random decision forest, or “random forest”. However, the two stages are not trained, modelled or implemented separately. Instead, as the random forest algorithms are run on the output layer of the neural network model, the random forest model is grouped with the neural network so that both models are defined and grouped in one step. This combined method helps to reduce errors.

To run the forest based regression on the last layer of neural network, in an exemplary embodiment about 100 decision trees are used to train the model. The decision trees model is fit on the training dataset.

In some embodiments, the programming and modelling may be done in Python using libraries such as Tensorflow, Keras, Pandas and Numpy.

### Model Evaluation

Once the model is compiled, trained and is fit, the next step is to evaluate the performance of the model using the loss function, in this example a mean squared error. The mean squared error measures how close a regression line is to a set of data points. It is a risk function corresponding to the expected value of the squared error loss. Mean squared error is calculated by taking the mean of errors squared from the data as it relates to a function.

In the example described herein, the validation dataset's mean squared error reduced from 139883 in the neural network to 27584 in the random forest regression. The hybrid model approach thus produces a more accurate prediction than individually training the model using neural networks and then random forest regression.

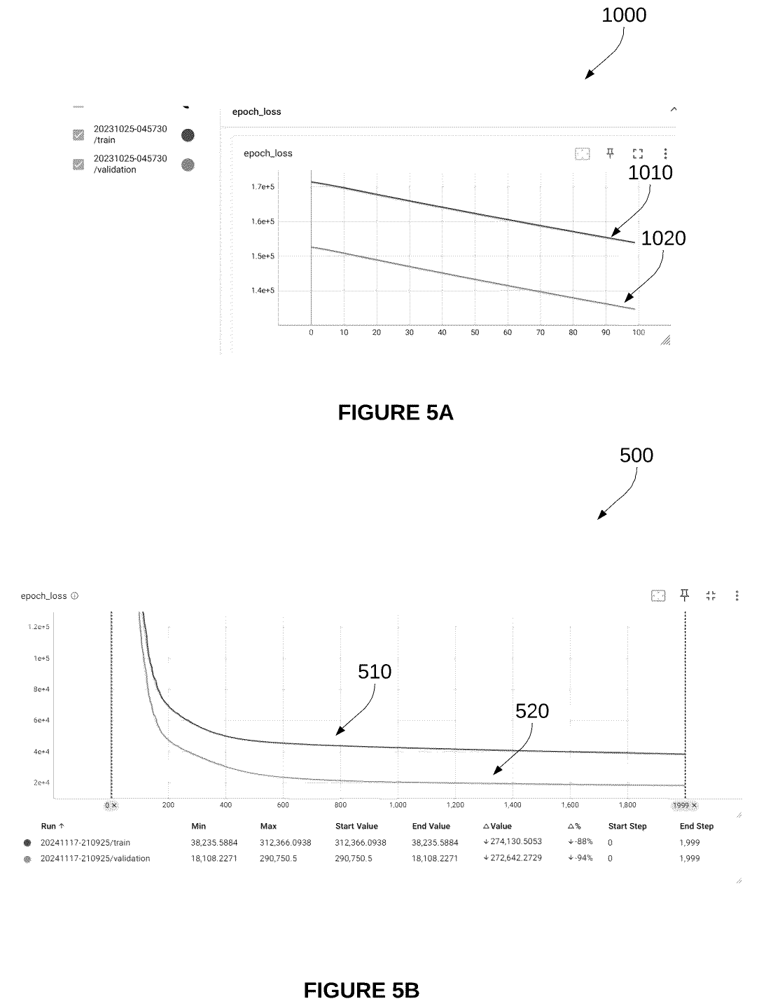

FIG. 5A of the drawings illustrates a loss function comparison 1000 between training data 1010 and test data 1020, with the loss value on the Y-axis and the number of epochs on the X-axis. The graph shows the reduction in loss for both the training data and the test data as the epochs increase. The validation data has lower loss than the training data with the same number of epochs. This is generally a sign of a model that does not suffer from over-fitting.

FIG. 5B of the drawings illustrates a loss function comparison 500 between training data 510 and validation data 520, with the loss value on the Y-axis and the number of epochs on the X-axis.

As part of the validation process, various tests may be used to determine the best model to predict attributes or parameters that a user may be interested in, for example room prices in the example of accommodation. Table 2 shows examples of tests that may be conducted, along with diagnostics that may be used to select an appropriate model. Where a model is selected based on the lowest loss, it can be seen from Table 2 that Test 17 would be selected as the final model due to the lowest loss (MSE) value of 27584.

TABLE 2
Validation Tests

| | | | Structure of neural | |
|---|---|---|---|---|
| | | Neural net Mean | network random | Mean squared |
| | Structure of neural | squared error | forest model | error - random |
| Test | net model only | (MSE) | together | forest model |
| Test 1 | Dense (32) + | Test MSE: 242252 | Dense (32) + last | 32469 |
| | output (Dense (1)) | | layer (Dense (8)) | |
| | Epochs = 100 | | Trees = 100 | |
| Test 2 | Dense (16) + | Test MSE: 242172 | Dense (16) + last | 33050 |
| | output (Dense (1)) | | layer (Dense (8)) | |
| | Epochs = 200 | | Trees = 100 | |
| Test 3 | Dense (16) + | Test MSE: 242172 | Dense (16) + last | 33095 |
| | output (Dense (1)) | | layer (Dense (8)) | |
| | Epochs = 100 | | Trees = 200 | |
| Test 4 | Dense (32) + | Test MSE: 257069 | Dense (32) + last | 32685 |
| | output (Dense (1)) | | layer (Dense (8)) | |
| | Epochs = 100 | | Trees = 100 | |
| Test 5 | Dense (32) + | Test MSE: 257069 | Dense (32) + last | 32700 |
| | output (Dense (1)) | | layer (Dense (8)) | |
| | Epochs = 100 | | Trees = 200 | |
| Test 6 | Dense (32) + | Test MSE: 253118 | Dense (32) + last | 31842 |
| | output (Dense (1)) | | layer (Dense (16)) | |
| | Epochs = 100 | | Trees = 100 | |
| Test 7 | Dense (32) + | Test MSE: 253118 | Dense (32) + last | 31458 |
| | output (Dense (1)) | | layer (Dense (16)) | |
| | Epochs = 100 | | Trees = 200 | |
| Test 8 | Dense (32) + | Test MSE: 149410 | Dense (32) + last | 41397 |
| | output (Dense (1)) | | layer (Dense (16)) | |
| | Epochs = 200 | | Trees = 200 | |
| Test 9 | Dense (32) + | Test MSE: 110932 | Dense (32) + last | 44397 |
| | output (Dense (1)) | | layer (Dense (16)) | |
| | Epochs = 200 | | Trees = 100 | |
| Test 10 | Dense (64) + | Test MSE: 303151 | Dense (64) + last | 83860 |
| | output (Dense (1)) | (model overfits | layer (Dense (32)) | |
| | Epochs = 100 | as the training | Trees = 100 | |
| | | MSE is 226314) | | |
| Test 11 | Dense (16) + | Test MSE: 270183 | Dense (16) + last | 32569 |
| | output (Dense (1)) | | layer (Dense (8)) | |
| | Epochs = 100 | | Trees = 100 | |
| Test 12 | Dense (16) + | Test MSE: 207457 | Dense (16) + last | 32596 |
| | output (Dense (1)) | | layer (Dense (8)) | |
| | Epochs = 200 | | Trees = 200 | |
| Test 13 | Dense (16) + | Test MSE: 22247 | Dense (16) + last | 27672 |
| | output (Dense (1)) | | layer (Dense (8)) | |
| | Epochs = 100 | | Trees = 500 | |
| Test 14 | Dense (16) + | Test MSE: 20206 | Dense (16) + last | 27639 |
| | output (Dense (1)) | | layer (Dense (8)) | |
| | Epochs = 200 | | Trees = 1000 | |
| Test 15 | Dense (32) + | Test MSE: 34668 | Dense (32) + Dense | 29453 |
| | Dense (16) + | | (16) ++ last layer | |
| | output (Dense (1)) | | (Dense (8)) | |
| | Epochs = 200 | | Trees = 2000 | |
| Test 16 | Dense (32) + | Test MSE: 36094 | Dense (32) + Dense | 30293 |
| | Dense (16) + | | (16) ++ last layer | |
| | output (Dense (1)) | | (Dense (16)) | |
| | Epochs = 100 | | Trees = 2000 | |
| Test 17 | Dense (32) + | Test MSE: 139883 | Dense (32) ++ last | 27584 |
| | output (Dense (1)) | | layer (Dense (8)) | |
| | Epochs = 200 | | Trees = 2000 | |

Hyperparameters are configuration variables that govern the training process of a machine learning model. In some embodiments, the prediction model may be improved by tuning the hyperparameters (e.g., selecting then umber of hidden layers and/or the number of nodes for each layer in a neural network). As an example, a structure of Dense (128)+Dense (64)+output (Dense (1)) and Epochs=2000 that has a MSE of 17767 improves to a MSE of only 12397 for the combination neural network random forest model structure of Dense (128)+ layer (Dense (64)) with Trees=3000 when the hyperparameters are tuned for optimal results.

Tensorflow offers a hyperparameter_template which can be used, and beneficially this saves the developer choosing the best parameters individually.

### Model Prediction

Referring again to FIG. 4 of the drawings, at step 614 the trained machine learning model is applied to make predictions on new, unseen data. Pre-processed input data is provided to the trained model, a forward pass is performed through the neural network during which the input data is passed through the network layer by layer, applying the learned weights and activation functions at each layer. The output of the final layer of the neural network produces the inputs for the random forest layer in which each tree produces a prediction for the input data.

Post-processing may be applied to the model predictions. For example, the method may apply a confidence interval of 95% (standard deviation: 1.96) to determine the lower and upper bounds of the prediction interval.

The data inputs may include different types of information. In the example of aged care, these may include, e.g., stock condition and room sizes which do not typically change or do not change often/much. However, there are other factors which are dynamic and not stable. Factors such as median house price and occupancy levels do not tend to stay the same. Median house prices are an important factor to predict the room prices and are not stable. Because the room prices are in line with the housing market to ensure providers are not under-charging or over-charging, the predictions are time-dependent.

In an example embodiment, a first version of the app may be provided to the provider of accommodation, and a second version of the app may be provided to residents and prospective residents. In the first version, the displayed output may simply be a predicted cost (or predicted cost range) for a particular room based on attributes selected by the user (being from the perspective of the provider). In the second version, the displayed output may include post-processed predicted data.

### Method of Predicting and Recommending

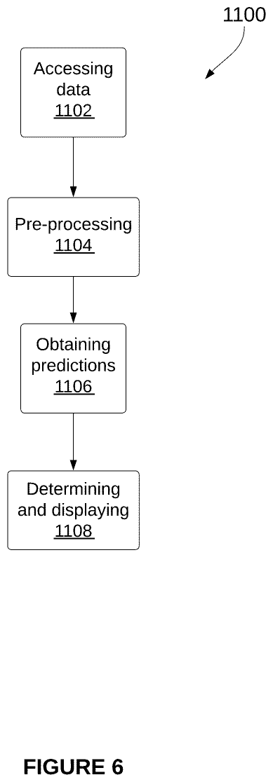

FIG. 6 of the drawings shows an example embodiment of a method 1100 of predicting and recommending attributes. The method includes, at 1102, accessing data related to at least one attribute or parameter, and at 1104, pre-processing the data by encoding the data to provide labelled data. The method includes, at 1106, obtaining a set of attribute predictions by applying the labelled data to a combination prediction model, wherein the combination prediction model comprises an integrated neural network and random forest model. The method 110 also includes, at 1108, determining and displaying a recommended subset of attribute predictions in response to a user selection.

In one exemplary embodiment, the method provides a user (for example a prospective resident of an aged care facility) with one or more accommodation recommendations. These may include, for example, recommending any one or more of a location, room type, and room size combination in response to a user-selected budget, or a budget range, room type, and room size, or combinations of these that match a user selection, for example that is available in a user-selected location, etc.

Similar to, for example, providing directions to a user to a point of interest according to congestion along travel routes provides benefits to the user in navigating to, and from, the point of interest, the provision of recommendations to users via the methods described herein gives rise to benefits to the user. For example, the user is provided with alternative options for location, alternative room sizes and/or types, alternative vendors, and/or room occupancy changes that may be applied to the accommodation selection in order to suit a cost requirement without compromising functional requirements of the accommodation.

The methods described herein comprise a combination of integers that solve a technical problem of determining alternative options for achieving a desired outcome and also providing visibility within the process.

The inventor has found a unique combination of features that is not only novel, but also provides the users of the method with benefits in navigating choices and decisions based on complex factors that are challenging to predict and need to be considered as a whole. Advantageously, the methods described allow for visibility regarding the impact of contributing factors.

Combining neural networks and random forests to solve a prediction problem is not a common practice due to fundamental differences in their design, operation, and strengths. Neural networks and random forests are fundamentally different approaches to machine learning. Neural networks excel at learning patterns in data through the optimisation of weights via backpropagation and gradient descent, making them particularly effective for high-dimensional, unstructured data such as images, text, or audio. Random forests, on the other hand, are ensemble methods based on decision trees, robustly handling structured or tabular data while providing interpretability through feature importance analysis and decision paths. These differences in their operational principles make it challenging to integrate the two models effectively.

Neural networks transform data into hierarchical, high-dimensional feature representations, while random forests rely on simpler feature spaces inherent in raw or pre-processed tabular data. This disparity in feature representation creates additional complexity when attempting to combine them. Furthermore, neural networks depend on gradient-based optimisation during training, whereas random forests, being non-parametric models, operate independently of such optimisation techniques. The incompatibility in training processes further complicates any effort to build a unified framework for these models.

Both neural networks and random forests have specific domains in which they excel. Neural networks are the preferred choice for unstructured data, while random forests are effective for structured data. When a task is well-suited to one model, incorporating the other rarely adds significant value and often introduces unnecessary complexity. This overlap in strengths makes their direct combination redundant in many cases. For all these reasons, combining these two approaches are counterintuitive and would not be an obvious approach.

However, the inventor has found that there are some scenarios where combining these approaches offer benefits as long as they are combined in the right way. For example, in cases involving heterogeneous data, such as a mixture of unstructured and structured features, a neural network might first extract embeddings from the unstructured data, which then serve as inputs to a random forest model. Specifically, the methods described herein use the random forest to replace the last neural network layer, and train both together at the same time.

Advantageously, the systems and methods described herein provide improved prediction results for complex problems. For example, energy demand and pricing can be more accurately predicted by taking into consideration weather patterns, energy production costs, cyclical demand fluctuations, government regulations, and market competition. Implemented with respect to energy trading, the methods herein can predict demand and optimise pricing to ensure market stability.

In healthcare, cost prediction can be improved through more accurate analysis of patient demographics, medical histories, insurance coverage, treatment types, regional healthcare pricing, and the like.

Supply chain predictions for planning purposes can be improved by taking into consideration raw material availability, production schedules, transportation costs, demand forecasting, geopolitical factors, and environmental conditions. The systems and methods described herein are capable of supporting dynamic pricing and inventory management to improve efficiency and reduce waste.

Smart city resource allocation exemplifies another intricate challenge, requiring coordination across transportation, utilities, public safety, and urban planning systems, all affected by factors such as population density, economic activity, and time of day. The methods described herein improve accuracy of predicting resource demands and optimise distribution to enhance urban living standards.

Advantageously, the methods described herein are suitable for financial risk assessment, which involves analysing complex variables like historical financial data, market trends, global economic conditions, regulatory changes, and individual behaviours. The prediction methods described herein can be used to evaluate these factors in order to mitigate risks in lending, investing, and insurance sectors.

Climate change modelling is another area that can benefit from the improved prediction methods described herein. By integrating atmospheric data, ocean currents, greenhouse gas emissions, economic activities, and biodiversity metrics, it is possible to predict and mitigate environmental impacts.

Retail demand prediction also depends on a wide range of factors, including consumer behaviour, seasonality, marketing effectiveness, competitor activity, and macroeconomic trends, which the methods described herein can analyse to optimise inventory and pricing strategies.

Agricultural yield forecasting represents a further example of a complex problem that can benefit from the methods described herein. Variables such as soil conditions, weather patterns, pest infestations, water availability, crop types, and market demand all contribute to the difficulty of predicting and improving yields.

It will be understood to persons skilled in the art of the invention that many modifications may be made without departing from the spirit and scope of the invention.

1. A computer-implemented method comprising:
accessing data related to at least one attribute of at least one item over time;
pre-processing the data by encoding the data to provide labelled data;
obtaining a set of attribute predictions by applying the labelled data to a combination prediction model, wherein the combination prediction model comprises two or more supervised learning workflows; and
determining and displaying a recommended subset of attribute predictions in response to a user selection,
wherein the two or more supervised learning workflows comprise:
an integrated neural network, and
a random forest model.

2. The method of claim 1, wherein the integrated neural network is followed by the random forest model, and the random forest model replaces a last layer, being an output layer, in the neural network.

3. The method of claim 1, wherein:
the combination prediction model has a depth between 15 and 40 layers, and
the random forest model has between 500 and 2,000 trees.

4. The method of claim 1, wherein the random forest has a leaf size of 5, and a mean tree depth of 18.

5. The method of claim 1, wherein the two or more supervised learning workflows comprise one or more of: a linear regression, simple regression, multiple regression, ensemble learning, a Support Vector Machine (SVM), K-Nearest Neighbours (KNN), a gradient boosting algorithm, and a logistic regression model.

6. The method of claim 1, wherein the combination prediction model is formed using joint, simultaneous training of the integrated neural network and the random forest model.

7. The method of claim 1, wherein the combination prediction model is trained by executing the integrated neural network and the random forest model in combination to classify training data.

8. The method of claim 1, wherein pre-processing the data comprises:
processing different data variables separately; and
joining the different data variables to form one data input comprising data variables from two or more feature categories.

9. The method of claim 8, wherein the one data input comprises a numerical data variable and a categorical data variable.

10. The method of claim 1, wherein pre-processing the data comprises converting all data to a numerical form usable by the integrated neural network.

11. The method of claim 1, wherein the integrated neural network comprises:
a body layer with about 32 dense layers; and
an output layer with about 8 dense layers,
wherein “dense layers” are layers that apply weights to substantially all nodes from a previous layer.

12. The method of claim 1, wherein the integrated neural network comprises:
an activation function; and
an optimisation algorithm.

13. A system comprising one or more processors with instructions to execute the method of claim 1.

14. A computer program comprising instructions which, when the program is executed by a computer, cause the computer to carry out the method of claim 1.

15. A computer-readable medium comprising instructions which, when executed by a computer, cause the computer to carry out the method of claim 1.
